(19) United States
(12) Patent Application Publication
(10) Pub. No.: US 2026/0295820 A1
(43) Pub. Date: Oct. 1, 2026

(54) System and method suitable for synchronizing actions of a mechanical device with a task progress of an agent

(71) Applicant: Mitsubishi Electric Research Laboratories, Inc., Cambridge, MA (US)

(72) Inventors: Diego Romeres, Boston, MA (US); Davide De Lazzari, Padua (IT); Giulio Giacomuzzo, Padua (IT); Siddarth Jain, Boston, MA (US); Pietro Falco, Padua (IT); Ruggero Carli, Padua (IT)

(73) Assignee: Mitsubishi Electric Research Laboratories, Inc., Cambridge, MA (US)

(21) Appl. No.: 19/094,529

(22) Filed: Mar. 28, 2025

(51) Int. Cl. B25J 9/16

(52) U.S. Cl. CPC B25J 9/163

(57) ABSTRACT

The present disclosure provides a system and a method for controlling a mechanical device in a collaborative environment to synchronize its actions with a task progress of an agent. The method includes receiving, in real time, a task completion percentage of a task being performed by the agent, and receiving an elapsed time since initiation of the task by the agent. The method further includes combining the task completion percentage and the elapsed time into an input state representation, and executing a trained policy derived from a reinforcement learning to determine, based on the input state representation, an action for the mechanical device. The method further includes controlling the mechanical device according to the determined action.

### TECHNICAL FIELD

The present disclosure relates generally to control systems, and more specifically to a system and a method for controlling a mechanical device in a collaborative environment to synchronize its actions with a task progress of an agent.

### BACKGROUND

Recent advancements in robotics and artificial intelligence (AI) have revolutionized industrial environments, significantly increasing deployment of robots in tandem with other agents, including human workers, to accomplish complex tasks. As the robots have become more sophisticated, they are now capable of performing a wide range of activities alongside the human workers in various sectors, such as manufacturing, logistics, and assembly. For instance, in assembly tasks, human-robot collaboration leverages precision and speed of the robot to complement dexterity and adaptability of the human workers. Such a multi-agent collaboration can lead to enhanced productivity and improved work quality for the human workers by allowing the robots to take over the most repetitive and physically demanding tasks.

However, effective human-robot collaboration requires careful task planning and assignment, which is challenging due to inherent variability in performance of the human workers. For instance, different human workers may require varying amounts of time to complete the same task, even when following a predefined sequence of actions. Mutual understanding between the human workers and robots is essential for successful collaboration, and timing plays a critical role in shaping interactions between the human workers and the robots. As a result, time and action synchronization becomes a crucial factor in facilitating safe, efficient, and productive interactions between the humans and the robots.

Therefore, there is a need for a system and a method that enables the robots to synchronize its action with the other agents, such as the human workers, to optimize collaborative workflows and ensure seamless task execution.

### SUMMARY

It is an objective of some embodiments to provide a system and a method controlling a mechanical device in a collaborative environment to synchronize its actions with a task progress of an agent. It is also an objective of some embodiments to minimize an idle time of the mechanical device and the agent while the mechanical device and the agent are working collaboratively in the collaborative environment. The collaborative environment includes the mechanical device and the agent. The mechanical device may be a robot, a digital phone, a smartwatch, or other wearable device. The agent is another mechanical device or a user working with the mechanical device. For the purpose of explanation, the mechanical device is considered to be the robot and the agent is considered to be the user.

The mechanical device and the agent are desired to work collaboratively to perform the task. For instance, the mechanical device is the robot and the agent is the user. The robot and the user are desired to work collaboratively to perform a task of assembling an object. In such a task, the robot and the user perform their tasks in collaboration, e.g., the robot assists the user to assemble the object by moving tools or passing the tools to the user as needed and the user grabs the passed tool from the robot and uses it to assemble the object.

Some embodiments are based on the recognition that mutual understanding between the mechanical device and the agent is essential for successful collaboration, and timing plays a critical role in shaping interactions between the mechanical device and the agent. In particular, the user is highly sensitive to the timing and smoothness of the interactions, making time synchronization crucial for seamless task execution.

Some embodiments are based on the realization that synchronization of time and actions between the mechanical device and the agent can be achieved by continuously tracking the task executed by the agent, not merely at fixed intervals but as a dynamic, ongoing process. This continuous tracking is beneficial for enabling the mechanical device to act proactively, reducing delays and promoting seamless collaboration, thereby enhancing the efficiency and fluency of the interactions in real-time applications.

Critically, the task tracking cannot rely solely on a single input, such as an elapsed time since initiation of the task by the agent or a task completion percentage of the task being performed by the agent, because each alone is insufficient to address inherent uncertainty of task progression. The elapsed time provides a temporal context, offering insights into how long the task has been in progress, but it lacks precision regarding an actual state of the task. Conversely, the task completion percentage—a predictive metric derived from real-time task monitoring—offers a snapshot of task progress but is inherently uncertain.

As time elapses, confidence in the task completion percentage grows because more data about the task's progress becomes available. At beginning of the task of the agent, predictions of the task completion percentage may vary significantly due to limited observations or unexpected deviations in the agent's behavior. However, as the task progresses and more elapsed time accumulates, these predictions stabilize, providing a more reliable signal to the mechanical device. This complementary relationship allows the mechanical device to better manage uncertainty and align its actions more effectively with the agent's progress.

By inputting both the elapsed time and the task completion percentage to the mechanical device, the mechanical device gains a nuanced understanding of collaborative dynamics. For example, such a dual-input approach (the elapsed time and the task completion percentage) enables the mechanical device to recognize when the agent is approaching a critical transition point in their task, and adjust its own timing to either assist or avoid interfering with the agent. Further, the dual-input approach enables the mechanical device handle variability in task execution, such as delays or accelerations, by relying on the growing confidence in the task completion percentage over time.

To this end, the elapsed time and the task completion percentage are input to a policy of the mechanical device trained with reinforcement learning (RL). The policy is a strategy or function that the mechanical device uses to decide what action to take in a given state. Based on the elapsed time and the task completion percentage, the policy determines an optimal action for the mechanical device such that the idle time of the mechanical device and/or the agent is minimized. The idle time of the agent refers to the time that the agent waits before executing its actions. The idle time of the mechanical time refers to the time that the mechanical device waits before executing its actions.

Inclusion of the elapsed time and the task completion percentage as state variables ensures that the mechanical device's policy accounts for temporal dynamics and task-specific progress in a structured way. Further, discrete nature of the elapsed time and the task completion percentage simplifies training process of the policy using RL, as the RL can efficiently learn relationships between the elapsed time, the task completion percentage, and the optimal action.

Therefore, by leveraging both the elapsed time and the task completion percentage, the mechanical device can achieve a higher level of collaboration fluency, reducing the idle times for both itself and the agent while adapting to inherent uncertainties of real-world tasks. The dual-input approach enables proactive and intelligent decision-making in dynamic, multi-agent environments.

Accordingly, one embodiment discloses a method for controlling a mechanical device in a collaborative environment to synchronize its actions with a task progress of an agent. The method uses a processor coupled with stored instructions implementing the method, wherein the instructions, when executed by the processor carry out steps of the method, comprising: receiving, in real time, a task completion percentage of a task being performed by the agent, wherein the task completion percentage is dynamically estimated from observations of task progress data; receiving an elapsed time since initiation of the task by the agent; combining the task completion percentage and the elapsed time into an input state representation; executing a trained policy derived from a reinforcement learning to determine, based on the input state representation, an action for the mechanical device; and controlling the mechanical device according to the determined action.

Accordingly, another embodiment discloses a system for controlling a mechanical device in a collaborative environment to synchronize its actions with a task progress of an agent. The system comprises: a processor; and a memory having instructions stored thereon that, when executed by the processor, cause the system to: receive, in real time, a task completion percentage of a task being performed by the agent, wherein the task completion percentage is dynamically estimated from observations of task progress data; receive an elapsed time since initiation of the task by the agent; combine the task completion percentage and the elapsed time into an input state representation; execute a trained policy derived from a reinforcement learning to determine, based on the input state representation, an action for the mechanical device; and control the mechanical device according to the determined action.

Accordingly, yet another embodiment discloses a non-transitory computer-readable storage medium embodied thereon a program executable by a processor for performing a method for controlling a mechanical device in a collaborative environment to synchronize its actions with a task progress of an agent. The method comprises receiving, in real time, a task completion percentage of a task being performed by the agent, wherein the task completion percentage is dynamically estimated from observations of task progress data; receiving an elapsed time since initiation of the task by the agent; combining the task completion percentage and the elapsed time into an input state representation; executing a trained policy derived from a reinforcement learning to determine, based on the input state representation, an action for the mechanical device; and controlling the mechanical device according to the determined action.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a collaborative environment for performing a task, according to an embodiment of the present disclosure.

FIG. 2A shows a block diagram of a method for controlling a mechanical device in the collaborative environment synchronize its actions with a task progress of an agent, according to an embodiment of the present disclosure.

FIG. 2B shows a system for controlling the mechanical device in the collaborative environment to synchronize its actions with the task progress of the agent, according to some embodiments of the present disclosure.

FIG. 3 illustrates a training process for training a policy of the mechanical device, according to some embodiments of the present disclosure.

FIG. 4 illustrates a weighted combination of an idle time of the mechanical device and an idle time of agent, according to an embodiment of the present disclosure.

FIG. 5 illustrates a block diagram for estimating a task completion percentage using a covariance based open-ended Dynamic Time Warping (DTW) algorithm, according to some embodiment of the present disclosure.

FIG. 6A illustrates a multi-agent system, according to some embodiments of the present disclosure.

FIG. 6B illustrates controlling of an ego robot to synchronize its actions with a task of another robot to perform an assembly task, according to some embodiments of the present disclosure.

FIG. 7 illustrates a collaborative environment including an assembly robot and a user working collaboratively, according to an embodiment the present disclosure.

FIG. 8 is a schematic illustrating by non-limiting example a computing apparatus for implementing the methods and the systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

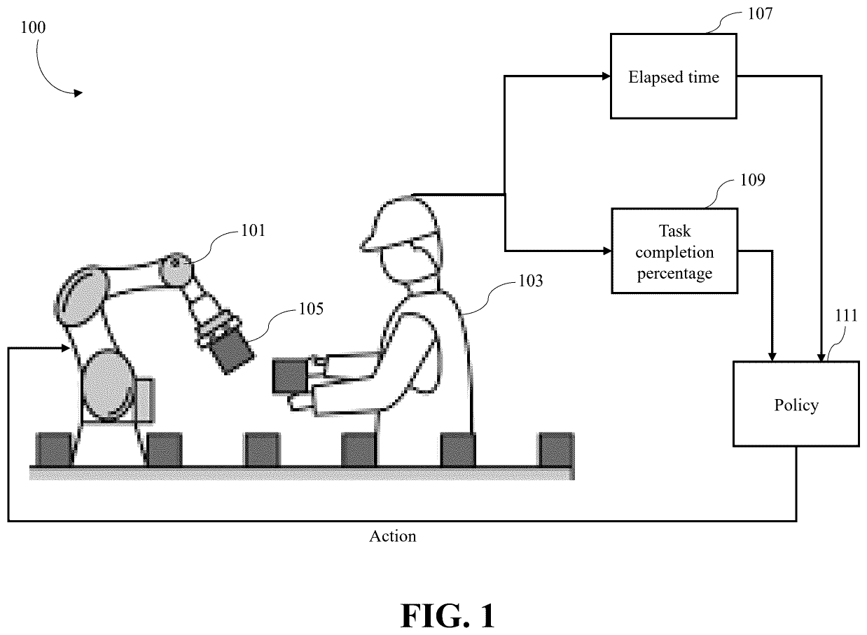

FIG. 1 illustrates a collaborative environment 100 for performing a task, according to an embodiment of the present disclosure. The collaborative environment 100 includes a mechanical device 101 and an agent 103. The mechanical device 101 may be a robot, a digital phone, a smartwatch, or other wearable device. The agent 103 is another mechanical device or a user working with the mechanical device 103. For the purpose of explanation, the mechanical device 101 is considered to be the robot and the agent 103 is considered to be the user.

The mechanical device 101 and the agent 103 are desired to work collaboratively to perform the task. For instance, the mechanical device 101 is the robot and the agent 103 is the user. The robot and the user are desired to work collaboratively to perform a task of assembling an object. In such a task, the robot and the user perform their tasks in collaboration, e.g., the robot assists the user to assemble the object by moving tools 105 or passing the tools 105 to the user as needed and the user grabs the passed tool 105 from the robot and uses it to assemble the object.

Some embodiments are based on the recognition that mutual understanding between the mechanical device 101 and the agent 103 is essential for successful collaboration, and timing plays a critical role in shaping interactions between the mechanical device 101 and the agent 103. In particular, the user is highly sensitive to the timing and smoothness of the interactions, making time synchronization crucial for seamless task execution.

Some embodiments are based on the realization that synchronization of time and actions between the mechanical device 101 and the agent 103 can be achieved by continuously tracking the task executed by the agent 103, not merely at fixed intervals but as a dynamic, ongoing process. This continuous tracking is beneficial for enabling the mechanical device 101 to act proactively, reducing delays and promoting seamless collaboration, thereby enhancing the efficiency and fluency of the interactions in real-time applications.

Critically, the task tracking cannot rely solely on a single input, such as an elapsed time 107 since initiation of the task by the agent 103 or a task completion percentage 109 of the task being performed by the agent 103, because each alone is insufficient to address inherent uncertainty of task progression. The elapsed time 107 provides a temporal context, offering insights into how long the task has been in progress, but it lacks precision regarding an actual state of the task. Conversely, the task completion percentage 109—a predictive metric derived from real-time task monitoring—offers a snapshot of task progress but is inherently uncertain.

As time elapses, confidence in the task completion percentage 109 grows because more data about the task's progress becomes available. At beginning of the task of the agent 103, predictions of the task completion percentage 109 may vary significantly due to limited observations or unexpected deviations in the agent's behavior. However, as the task progresses and more elapsed time accumulates, these predictions stabilize, providing a more reliable signal to the mechanical device 101. This complementary relationship allows the mechanical 101 device to better manage uncertainty and align its actions more effectively with the agent's 103 progress.

By inputting both the elapsed time 107 and the task completion percentage 109 to the mechanical device 101, the mechanical device 101 gains a nuanced understanding of collaborative dynamics. For example, such a dual-input approach (the elapsed time 107 and the task completion percentage 109) enables the mechanical device 101 to recognize when the agent 103 is approaching a critical transition point in their task, and adjust its own timing to either assist or avoid interfering with the agent 103. Further, the dual-input approach enables the mechanical device 101 handle variability in task execution, such as delays or accelerations, by relying on the growing confidence in the task completion percentage 109 over time.

To this end, the elapsed time 107 and the task completion percentage 109 are input to a policy 111 of the mechanical device 101 trained with reinforcement learning (RL). The policy 111 is a strategy or function that the mechanical device 101 uses to decide what action to take in a given state. Based on the elapsed time 107 and the task completion percentage 109, the policy 111 determines an optimal action for the mechanical device 101 such that an idle time of the mechanical device 101 and/or the agent 103 is minimized. The idle time of the agent 103 refers to the time that the agent 103 waits before executing its actions. The idle time of the mechanical time 101 refers to the time that the mechanical device 101 waits before executing its actions.

Inclusion of the elapsed time 107 and the task completion percentage 109 as state variables ensures that the mechanical device's policy 111 accounts for temporal dynamics and task-specific progress in a structured way. Further, discrete nature of the elapsed time 107 and the task completion percentage 109 simplifies training process of the policy 111 using RL, as the RL can efficiently learn relationships between the elapsed time 107, the task completion percentage 109, and the optimal action.

Therefore, by leveraging both the elapsed time 107 and the task completion percentage 109, the mechanical device 101 can achieve a higher level of collaboration fluency, reducing the idle times for both itself and the agent 103 while adapting to inherent uncertainties of real-world tasks. The dual-input approach enables proactive and intelligent decision-making in dynamic, multi-agent environments.

Based on the dual-input approach described above, some embodiments of the present disclosure provide a method for controlling the mechanical device 101 in the collaborative environment 100 to synchronize its actions with the task progress of the agent 103.

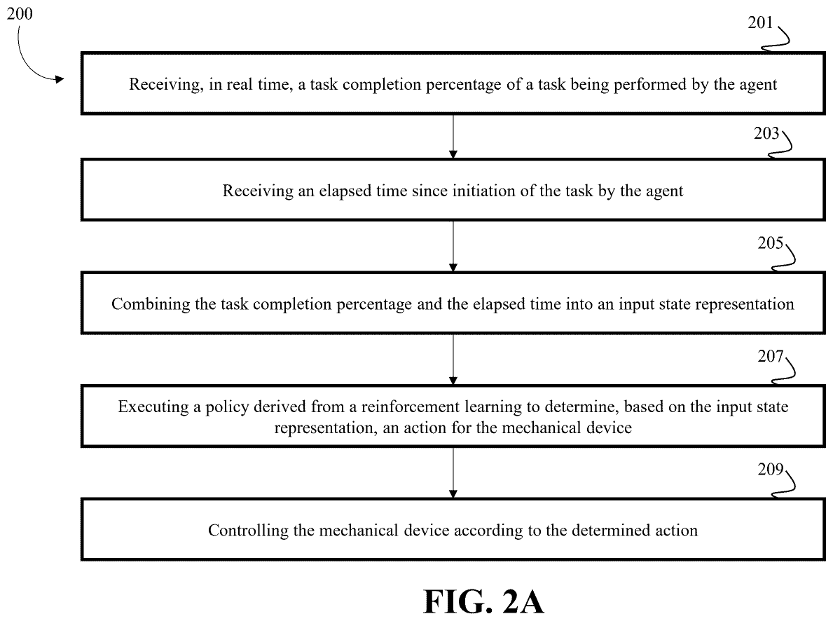

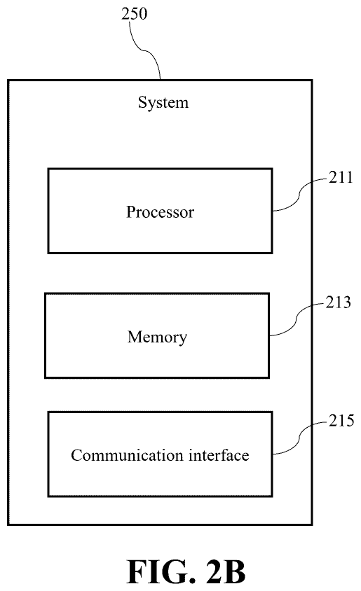

FIG. 2A shows a block diagram of a method 200 for controlling the mechanical device 101 in the collaborative environment 100 to synchronize its actions with the task progress of the agent 103, according to an embodiment of the present disclosure. At step 201, the method 200 includes receiving, in real time, a task completion percentage of a task being performed by the agent 103. The task completion percentage is dynamically estimated from observations of task progress data. The observations of task progress data include a trajectory over time of the motion of the agent 103. In some embodiments, the observations of task progress data include position of hands of the user tracked over time by use of inertial sensors, visual sensors, wearable tracking gloves, and/or motion capture sensors.

At step 203, the method 200 includes receiving an elapsed time since initiation of the task by the agent. The elapsed time is calculated as a difference between a current timestamp during task execution and a timestamp marking task initiation. The task initiation timestamp/point is identified by an action recognition system that employs sensor data to detect when the agent transitions from one task to another. This detection can be accomplished, for instance, by recognizing a change in the tool utilized by the agent, detecting completion signals from previous tasks, monitoring alterations in agent movements or posture indicative of a new task, or identifying sensor-detectable environmental changes consistent with start of a new activity.

At step 205, the method 200 includes combining the task completion percentage and the elapsed time into an input state representation. At step 207, the method 200 includes executing a policy (i.e., the policy 111) derived from the RL to determine, based on the input state representation, an action for the mechanical device 101. For example, the action includes one or a combination of a position, a velocity, and an orientation of the robot for passing the tool, moving the tool, holding the tool to support the agent 103, or jointly transporting an assembly piece by the mechanical device 101 and the agent 103.

At step 209, the method 200 includes controlling the mechanical device 101 according to the determined action. In an embodiment, to control the mechanical device 101 according to the determined action, the method 200 includes determining control commands to one or more actuators of the mechanical device 101 based on the determined action, and applying the control commands to the one or more actuators of the mechanical device 101 to execute the action. The determined action minimizes the idle time of the mechanical device 101 and/or the agent 103. Thereby, controlling the mechanical device 101 according to the determined action executes the task with the minimized idle times, thereby efficiently performing the task.

FIG. 2B shows a system 250 for controlling the mechanical device 101 in the collaborative environment 100 to synchronize its actions with the task progress of the agent 103, according to some embodiments of the present disclosure. The system 250 is communicatively coupled to the mechanical device 101. In some other embodiments, the system 250 is integrated into the mechanical device 101.

The system 250 includes a processor 211, a memory 213, and a communication interface 215. The processor 211 may be a single core processor, a multi-core processor, a computing cluster, or any number of other configurations. The memory 213 may include random access memory (RAM), read only memory (ROM), flash memory, or any other suitable memory systems. Additionally, in some embodiments, the memory 213 may be implemented using a hard drive, an optical drive, a thumb drive, an array of drives, or any combinations thereof. The memory 213 having instructions stored thereon that, when executed by the processor 211, cause the processor 211 to execute the steps 201-209 described above in FIG. 2A and other steps executed for controlling the mechanical device 101 in the collaborative environment 100.

The communication interface 215 may be any means such as a device or circuitry embodied in either hardware or a combination of hardware and software that is configured to receive and/or transmit data from/to other electronic devices in communication with the system 250. In this regard, the communication interface 215 may include, for example, an antenna (or multiple antennas) and supporting hardware and/or software for enabling communications with a plurality of different types of networks, such as first and second types of networks. Additionally or alternatively, the communication interface 215 may include the circuitry for interacting with the antenna(s) to cause transmission of signals via the antenna(s) or to handle receipt of signals received via the antenna(s).

The policy of the mechanical device 101 executed at step 207 is trained with the RL offline, in advance. In some other embodiments, the policy of the mechanical device 101 is trained with the RL online, i.e., in real-time.

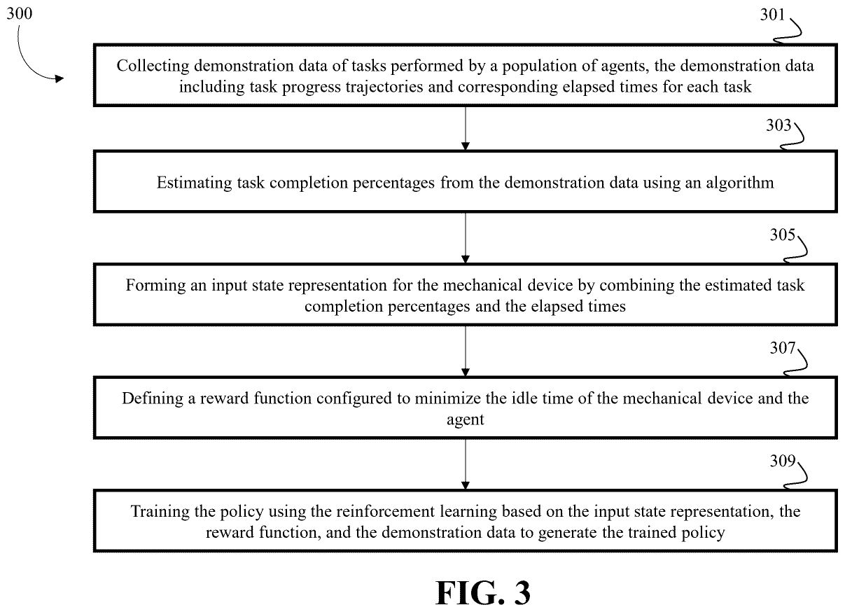

FIG. 3 illustrates a training process 300 for training the policy of the mechanical device 101, according to some embodiments of the present disclosure. At block 301, the training process 300 includes collecting demonstration data of tasks performed by a population of agents. The population of agents may include any number of agents 103. The demonstration data includes task progress trajectories and corresponding elapsed times for each task.

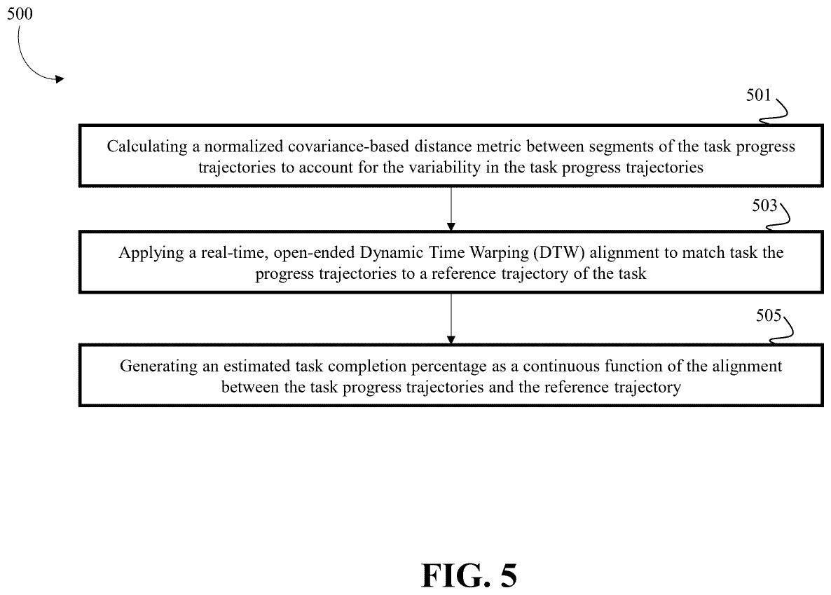

At block 303, the training process 300 includes estimating task completion percentages for each task from the demonstration data, using an algorithm. The algorithm accounts for variability in the task progress trajectories while estimating the task completion percentages. In an embodiment, the algorithm is Dynamic Time Warping (DTW) algorithm. The estimation of the task completion percentage is explained in detail in FIG. 5.

At block 305, the training process 300 includes forming an input state representation for the mechanical device 101 by combining the estimated task completion percentages and the elapsed times. At block 307, the training process 300 includes defining a reward function configured to minimize the idle time for the mechanical device 101 and the agent 103.

At block 309, the training process 300 includes training the policy using the RL based on the input state representation, the reward function, and the demonstration data to generate the trained policy.

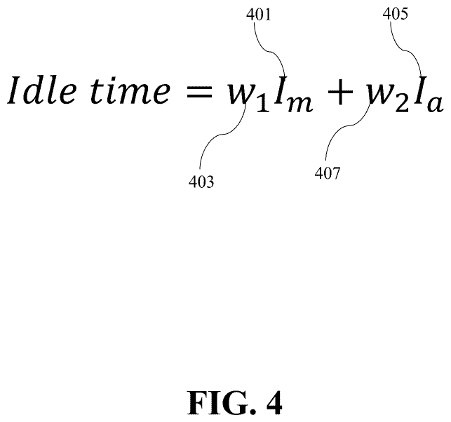

In an embodiment, the idle time that is minimized includes a weighted combination of the idle time of the mechanical device 101 and the idle time of agent 103. FIG. 4 illustrates the weighted combination of the idle time of the mechanical device 101 and the idle time of agent 103, according to an embodiment of the present disclosure. An idle time (Iₘ) 401 of the mechanical device 101 is assigned with a weight (w₁) 403, and an idle time (Iₐ) 405 of the agent 103 is assigned with a weight (w₂) 407. The weights 403 and 407 are configurable to give a desired importance to the mechanical device 101 and the agent 103, respectively. In an embodiment, the weights 403 and 407 are configured based on predefined task requirements to prioritize an efficiency of the mechanical device 101 or the other agent. The predefined task requirements include a cost of employing the user or the robot as the mechanical device 101 to complete the assembly task. In some embodiments, the cost of the user is estimated to be three times the cost of the robot mechanical device, which means for example that w₂=3w₁.

Some embodiments use a real-time, open-ended DTW alignment for estimating the task completion percentage of the task being performed by the agent 103. Unlike traditional DTW, which assumes a full task progress trajectory is available for analysis, the open-ended DTW operates incrementally, processing the task progress trajectory that evolves with time. This capability is essential for real-time applications, where decisions must be made without waiting for the full task progress trajectory. By dynamically aligning the evolving task progress trajectory with a reference trajectory, a continuously updated estimate of the task completion percentage is provided, enabling more adaptive and synchronized actions.

The “open-ended” nature of the open-ended DTW alignment allows the alignment to adjust on the fly, refining the alignment between the task progress trajectory and the reference trajectory as new data related to the task progress becomes available to the system 250. At the beginning of the task, when only partial data is available, the alignment may be less precise. However, as the time progresses and the new data related to the task progress are observed, the alignment becomes increasingly accurate. This incremental process ensures that even under conditions of uncertainty or variability in task execution, the alignment adapts dynamically to provide meaningful insights into the task progression.

Some embodiments further enhance the open-ended DTW alignment by using a covariance-based distance metric to compare segments of the task progress trajectories. Unlike other metrics such as Euclidean distance, which are sensitive to global shifts in amplitude or position of the task progress trajectories, the covariance-based metric normalizes amplitude differences between the segments of the task progress trajectories. This results in an online-capable, covariance-based open-ended DTW algorithm that directly compares task progress trajectory shapes through local correlation analysis, while preserving DTW's temporal elasticity. For example, the covariance-based open-ended DTW algorithm handles cases where two agents perform similar tasks with variations in speed or range of motion. This robustness ensures the open ended DTW alignment can effectively align the task progress trajectories with the reference trajectory even in noisy, real-world scenarios, where such variations are inevitable.

By integrating the covariance-based distance metric into the open-ended DTW alignment, the mechanical device 101 achieves robust and scalable synchronization with the agent's task progress, significantly enhancing the quality of collaborative interactions and ensuring real-time adaptability in dynamic environments.

FIG. 5 illustrates a block diagram for estimating the task completion percentage using the covariance based open-ended DTW algorithm, according to some embodiment of the present disclosure. At block 501, the method 500 includes calculating a normalized covariance-based distance metric between segments of the task progress trajectories to account for the variability in the task progress trajectories. The normalized covariance-based distance metric is invariant to shifts in the position or the amplitude of the task progress trajectories.

At block 503, the method 500 includes applying the real-time, open-ended DTW alignment to match task the progress trajectories to a reference trajectory of the task. The reference trajectory represents a baseline or typical execution of the task. At block 505, the method 500 includes generating an estimated task completion percentage as a continuous function of the alignment between the task progress trajectories and the reference trajectory.

The covariance based open-ended DTW algorithm is mathematically described below.

For the purpose of explanation here, the mechanical device 101 is considered to be the robot and the agent is considered to be the user. The user and the robot perform separate tasks concurrently. The robot executes a sequence of M robot-task actions

$${\{ {a}_{i}^{R} \}}_{i = 1}^{M} ,$$

which is repeated indefinitely. Simultaneously, the user performs a sequence of N user actions, denoted by

$$H = {\{ {a}_{j}^{H} \}}_{j = 1}^{N} .$$

The user requires the robot's assistance to complete a subset of these actions, referred to as joint actions and denoted by where

$$J = {\{ {a}_{l}^{J} \}}_{l = 1}^{L} ,$$

J⊆H. An operator α(⋅) is defined to map an index of a joint action to a corresponding user action index, such that

$${a}_{α ( l )}^{H} = {a}_{l}^{J} .$$

Without loss of generality, some embodiments assume that the last user action is a joint action

$$( i . e . , {a}_{N}^{H} = {a}_{L}^{J} ) ,$$

and no two consecutive user actions are joint actions

$$( i . e . , if {a}_{j}^{H} ∈ J , then {a}_{j + 1}^{H} ∉ J ) .$$

To assist the user, the robot must first complete a current robot-task action

$${a}_{i}^{R}$$

before pausing its ongoing task. Once paused, the robot performs a preparatory action (e.g., repositioning or collecting a tool) to prepare for the joint action. After completing the joint action, the robot executes a homing action before either resuming with the robot-task or preparing for the next joint action. Sets of preparatory and homing actions are denoted as

$${\{ {a}_{l}^{P} \}}_{l = 1}^{L} and {\{ {a}_{l}^{E} \}}_{l = 1}^{L} ,$$

respectively. Additionally, a set of Q demonstrations, consisting of user trajectories

$${Y}_{j} = {\{ {y}_{k}^{j} \}}_{k = 1}^{Q}$$

for each non-joint user action H\J is given. Each trajectory consists of Cartesian position of user hand along the x-, y-, and z-axes.

It is an objective of some embodiments to minimize idle times for both robot and the user, the time each of them waits for the other before starting the joint actions. To this end, a cost function is defined as:

$$C ( {I}_{m} , {I}_{a} ) = {w}_{1} {I}_{m} + {w}_{2} {I}_{a} , \qquad ( 1 )$$

where Iₘ is the robot total idle time 401 with a weight (w₁) 403 and Iₐ is the user idle time 405 with a weight (w₂) 407.

Some embodiments are based on the recognition that the open-ended DTW alignment lacks regularization, often producing unrealistic warping paths when applied to user motion, where trajectories can vary significantly in shape and amplitude. To address these challenges, soft-DTW introduces a differentiable soft-minimum operator, which smooths an alignment cost by weighing all possible warping paths. This approach has demonstrated superior performance in tasks such as time-series clustering and temporal signal matching, offering greater robustness to variations in position and speed.

The open-ended and soft versions of DTW are combined to develop an open-ended soft DTW algorithm. In the open-ended soft DTW algorithm, δ denotes a distance function between signal points, typically Euclidean distance in DTW, and minY represents a soft-minimum operator. The open-ended soft DTW algorithm computes a phase of a query signal relative to a reference signal, defined as a percentage of the reference trajectory matched up to the current time step. Given an alignment π that maps each index i of the query signal with an index j* of the reference trajectory, the phase at timestep i is computed as:

$${τ}_{i} = \frac{π ( i )}{n - 1} , \qquad ( 2 )$$

where n is a length of the reference trajectory. The phase τᵢ quantifies the task completion percentage as a value in [0,1]. However, the Euclidean distance employed fails to align signals that have both local shape variations and substantial shifts in absolute positions, often present in complex motion patterns.

To overcome these limitations, some embodiments introduce the correlation-based distance metric called Windowed-Pearson (WP) distance, which normalizes amplitude differences over windows during alignment. This results in an online-capable method that directly compares trajectory shapes through local correlation analysis, while preserving DTW's temporal elasticity. Windowed-Pearson distance between two signal samples is defined as:

$${δ}_{WP}^{w} ( {p}_{i} , {q}_{j} ) := {\sum }_{k = 0}^{d - 1} ( 1 - \frac{Cov ( {p}_{i - w + 1 : i , k} , {q}_{j - w + 1 : j , k} )}{\sqrt{Var ( {p}_{i - w + 1 : i , k} ) Var ( {q}_{j - w + 1 : j , k} )}} ) \qquad ( 3 )$$

where w represents a window size, and p_{i:j,k} denotes a subsequence of p along the k-th dimension, spanning from index i to j. The same notation applies to q. A combination of the open-ended soft DTW with the WP distance is referred to as the covariance based open-ended DTW algorithm.

The covariance based open-ended DTW algorithm depends on two parameters, the smoothing factor γ and the window size w. Rather than tuning these parameters manually, some embodiments optimize them automatically. Specifically, Bayesian optimization is used to minimize a mean squared error between a phase τᵢ estimated by the covariance based open-ended DTW algorithm and the phase corresponding to a linear progression

$${\overline{τ}}_{i} = \frac{i}{m - 1}$$

computed a posteriori, where m is a length of the query trajectory. For each action, one trajectory is selected as the reference, while the remaining ones are used to tune the parameters.

The interaction between the user and the robot is modeled as a finite-horizon episodic Partially Observable Markov Decision Process (POMDP). In POMDP, the robot acts as an agent that makes binary decisions between each robot-task action—whether to assist the user or not—while the user is treated as part of the collaborative environment. The POMDP is formally defined as a tuple (S, A, T, R, Ω, O), where S is a state space, A={0,1} is a set of policy actions (with 0 and 1 representing do not assist and assist, respectively), T (s, a, s′) is a state transition function, R(s, a, s′) is the reward function, Ω is an observation space, and O(s) is an observation function.

Each element of the state space S is defined as

$$s = ( {a}_{i}^{R} , {a}_{j}^{H} , {a}_{l}^{J} , {Δ}_{start}^{H} , {y}^{H} , {Δ}_{idle}^{R} , {Δ}_{idle}^{H} ) ,$$

where:

$${a}_{i}^{R}$$

denotes that last robot-task action,

$${a}_{j}^{H}$$

is a current user action,

$${a}_{l}^{J}$$

represents a joint action that user and robot should perform next,

$${Δ}_{start}^{H}$$

is the elapsed time from the start of the current user action

$${a}_{j}^{H} ,$$

y^{H} is a vector representing an observed user hand trajectory from the start of the current user action,

$${Δ}_{idle}^{R} and {Δ}_{idle}^{H}$$

are idle times of the robot and the user observed during the last transition.

The state transition function T(s, a, s′) P (s′|a, s) describes a probability of transitioning from state s to state

$${s}^{′} = ( {a}_{i ′}^{R} , {a}_{j ′}^{H} , {a}_{l ′}^{J} , {Δ}_{start}^{′ H} , {y}^{′ H} , {Δ}_{idle}^{′ R} , {Δ}_{idle}^{′ H} ) .$$

The state variables evolve as follows:

$$1 {a}_{i ′}^{R} = \{ \begin{matrix}{a}_{( i + 1 ) modM}^{R} & a = 0 \\ {a}_{i}^{R} & a = 1\end{matrix}$$

$${a}_{l ′}^{J} = \{ \begin{matrix}{a}_{l}^{J} & a = 0 \\ {a}_{l + 1}^{J} & a = 1\end{matrix} ,$$

while the remaining state variables are directly observed.

The reward function R(s, a, s′) is designed to minimize a total cost introduced in equation (1):

$$R ( s , a , {s}^{′} ) = - {w}_{1} {I}_{m} - {w}_{2} {I}_{a} . \qquad ( 4 )$$

The observation function is defined as

$$O ( s ) ( {a}_{i}^{R} , {a}_{j}^{H} , {Δ}_{s t art}^{H} , {τ}^{j} ( {y}^{H} ) ) ,$$

where τ^{j} (y^{H}) represents a phase of the user action

$${a}_{j}^{H} ,$$

computed from the observed user hand trajectory y^{H} using the covariance based open-ended DTW algorithm.

### Training

The reinforcement learning used for training the policy includes a Proximal Policy Optimization (PPO). The PPO is advantageous as due to its native support for state representations that encompass both discrete and continuous spaces, as well as its ability to handle discrete action spaces, and robustness in highly stochastic environments. Specifically, PPO's clipped surrogate objective ensures stable policy updates, while its on-policy advantage estimation mitigates high variance encountered in real-world user-robot interactions. This balance of simplicity, sample efficiency, and performance makes PPO particularly well-suited for user-robot collaboration, where data collection is costly.

To model the interactions between the robot and the user, a duration of each action assumed to follow a Gaussian distribution. Specifically,

$${Δ}_{k}^{X} ∼ N ( {μ}_{{X}_{k}} , {σ}_{{X}_{k}}^{2} ) ,$$

where∈{H, R, P, E} preparatory, and homing actions, respectively.

At the beginning of each action, durations user actions

$${\{ {Δ}_{j}^{H} \}}_{j = 1}^{N} ,$$

preparatory actions

$${\{ {Δ}_{l}^{P} \}}_{l = 1}^{L} ,$$

and homing actions

$${\{ {Δ}_{l}^{E} \}}_{l = 1}^{L}$$

are sampled. Then, one trajectory \tilde{y}ⱼ is sampled from the set of demonstrations Yⱼ for each non-joint action

$${a}_{j}^{H} .$$

To avoid overfitting on training data, time axis of each trajectory \tilde{y}ⱼ is rescaled to align with each sampled duration

$${Δ}_{j}^{H} .$$

As a result, each new trajectory represents either a compressed or stretched version of an actual demonstration.

By employing these quantities, the transitions of the POMDP are modeled as:

$$2 {a}_{j ′}^{H} = {β}_{( {a}_{j}^{H} , {Δ}_{start}^{H} )} ( Δ )$$

$${Δ}_{start}^{′ H} = Δ - {Δ}_{start}^{H} - {\sum }_{k = j}^{j ′ - 1} {Δ}_{k}^{H}$$

$${y}^{′ H} = {\tilde{y}}_{j ′} ( 0 : {Δ}_{start}^{′ H} )$$

$${Δ}_{idle}^{′ R} = \{ \begin{matrix}0 & a = 0 \\ max \{ 0 , {\sum }_{k = j}^{α ( l ) - 1} {Δ}_{k}^{H} - {Δ}_{start}^{H} - {Δ}_{l}^{P} \} & a = 1\end{matrix}$$

$${Δ}_{idle}^{′ H} = \{ \begin{matrix}max \{ 0 , {Δ}^{R} + {Δ}_{start}^{H} - {\sum }_{k = j}^{α ( l ) - 1} {Δ}_{k}^{H} \} & a = 0 \\ max \{ 0 , {Δ}_{l}^{P} + {Δ}_{start}^{H} - {\sum }_{k = j}^{α ( l ) - 1} {Δ}_{k}^{H} \} & a = 1\end{matrix}$$

$${Δ}^{R} ∼ N ( {μ}_{{R}_{i ′}} , {σ}_{{R}_{i ′}}^{2} )$$

is a duration of the robot-task

$${a}_{i ′}^{R} .$$

Δ is a duration of the transition:

$$Δ = \{ \begin{matrix}{Δ}^{R} & a = 0 \\ {Δ}_{l}^{P} + {Δ}_{α ( l )}^{H} + {Δ}_{l}^{E} & a = 1\end{matrix} .$$

β is a function that, given the current user action

$${a}_{j}^{H}$$

and its elapsed time

$${Δ}_{s t a r t}^{H} ,$$

returns ongoing user action after a time Δ, namely,

$${β}_{( {a}_{i}^{H} , {Δ}_{s t a r t}^{H} )} ( Δ ) * arg {min}_{{a}_{j ′}^{H}} \{ {j}^{′} \geq j \vert Δ \leq {\sum }_{k = j}^{j ′} {Δ}_{k}^{H} \} .$$

In some embodiments, the collaborative environment 100 includes a robotic multi-agent system in which the mechanical device 101 is an ego robot and the agent 103 is another robot collaborating with the ego robot.

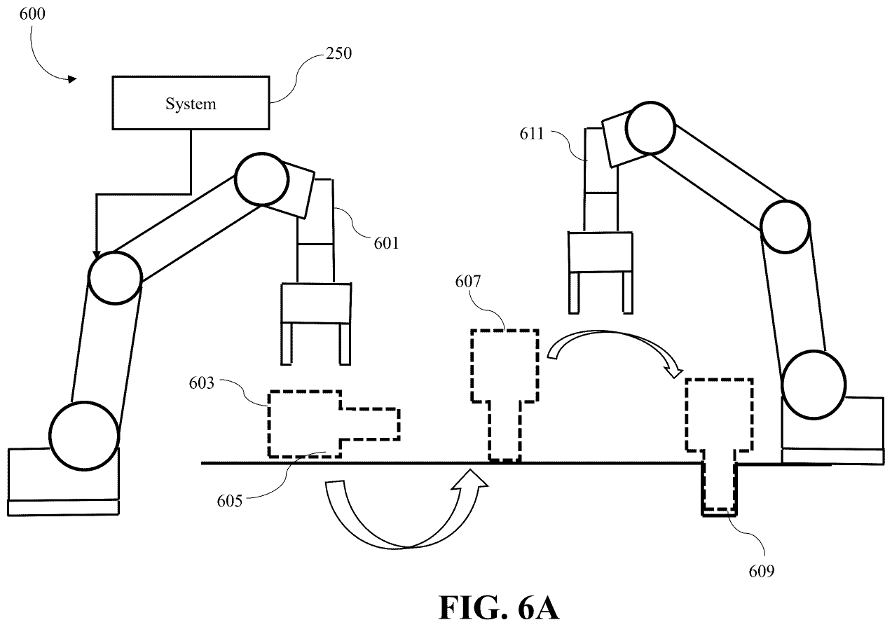

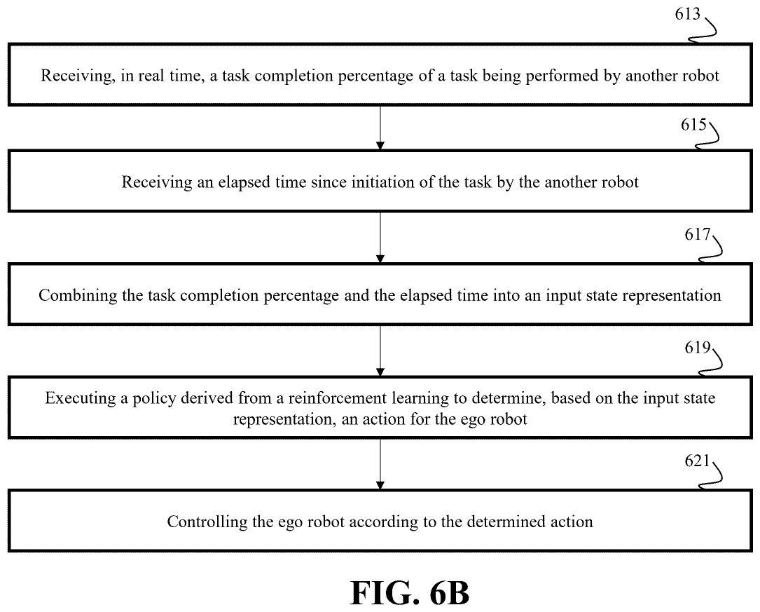

FIG. 6A illustrates a multi-agent system 600, according to some embodiments of the present disclosure. The multi-agent system 600 includes an ego robot 601 and another robot 611. The system 250 is communicatively coupled to the ego robot 601. The ego robot 601 and the another robot 611 are configured to work collaboratively to perform an assembly task. For instance, the ego robot 601 is configured to perform a task of manipulating a peg 603 in an initial pose 605 to a pose 607. Further, the another robot 611 is configured to perform a task grabbing the peg in the pose 707 and putting the peg into a hole 709. Timing and actions of the ego robot 601 and the another robot 611 are to be synchronized for smooth and timely execution of their tasks and the assembly task. The timing and actions of the ego robot 601 and the another robot 611 are synchronized by the system 250, as described below.

FIG. 6B illustrates controlling of the ego robot 601 to synchronize its actions with the task of the another robot 603 to perform the assembly task, according to some embodiments of the present disclosure. At block 613, the processor 211 of the system 250 is configured to receive, in real time, a task completion percentage of the task being performed by the another robot 611. At block 615, the processor 211 is configured to receive an elapsed time since initiation of the task by the another robot 611.

At block 617, the processor 211 is configured to combine the task completion percentage and the elapsed time into an input state representation. At block 619, the processor 211 is configured to execute the policy derived from the RL to determine, based on the input state representation, an action for the ego robot 601. The action includes one or a combination of a position, a velocity, and an orientation of the ego robot 601 for manipulating the peg 603 to the pose 607, so that the another robot 611 can further perform its task of putting the peg into the hole 609.

At block 621, the processor 211 is configured to control the ego robot 601 according to the determined action. In an embodiment, to control the ego robot 601 according to the determined action, the processor 211 is configured to determine control commands to one or more actuators of the ego robot 601 based on the determined action, and apply the control commands to the one or more actuators of the ego robot 601 to execute the action. The determined action minimizes an idle time of the ego robot 601 and/or the another robot 611. Thereby, controlling the ego robot 601 according to the determined action executes the assembly task with the minimized idle times, thereby efficiently performing the assembly task.

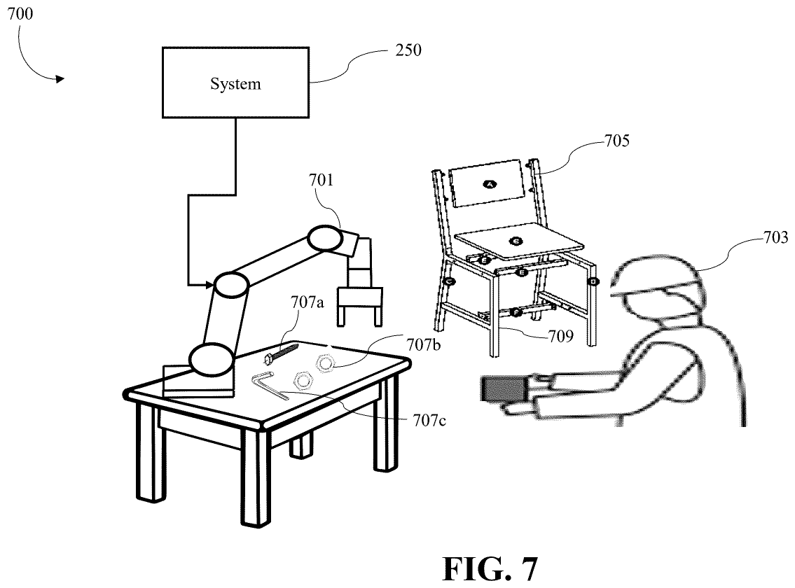

In some embodiments, the mechanical device 101 is an assembly robot and the agent 103 is a user performing a manual task. The assembly robot is configured to assist the user in performing the manual task, as described below in FIG. 7.

FIG. 7 illustrates a collaborative environment 700 including an assembly robot 701 and a user 703 working collaboratively, according to an embodiment the present disclosure. The system 250 is communicatively coupled to the assembly robot 701. The user 703 is tasked to perform a manual task of assembling parts 705 in a particular sequence to form an object, e.g., a chair. The assembly robot 701 is desired to assist the user 703 in assembling the parts 705 by passing different tools 707a-707c to the user 101 in a particular order while the user 703 is assembling parts 705 in the particular sequence. For example, when the user assembling legs 709 of the chair, the assembly robot 701 is configured to pass allen key 707c to tighten bolts and screws of the legs 709. The user 703 grabs the paased allen key 707c from the assembly robot 701 and uses it to assemble the legs 709.

Such actions of the robot 101 has to be synchronized with the assembly task being performed by the user 703, to ensure smooth and timely execution of the assembly task. To this end, the processor 211 of the system 250 is configured to receive, in real time, a task completion percentage of a task being performed by the user 703. Further, the processor 211 is configured to receive an elapsed time since initiation of the task by the user 703.

Further, the processor 211 is configured to combine the task completion percentage and the elapsed time into an input state representation, and execute the policy derived from the RL to determine, based on the input state representation, an action for the assembly robot 701. The action includes moving one of the tools 707a-707c, holding one of the tools 707a-707c or passing one of the tools 707a-707c by the assembly robot 701 to the user 703 to assist in assembling the parts 705.

Further, the processor 211 is configured to control the assembly robot 701 according to the determined action. The determined action minimizes an idle time of the assembly robot 701 and/or the user 703. Thereby, controlling the assembly robot 701 according to the determined action executes the assembly task with the minimized idle times, thereby efficiently performing the assembly task.

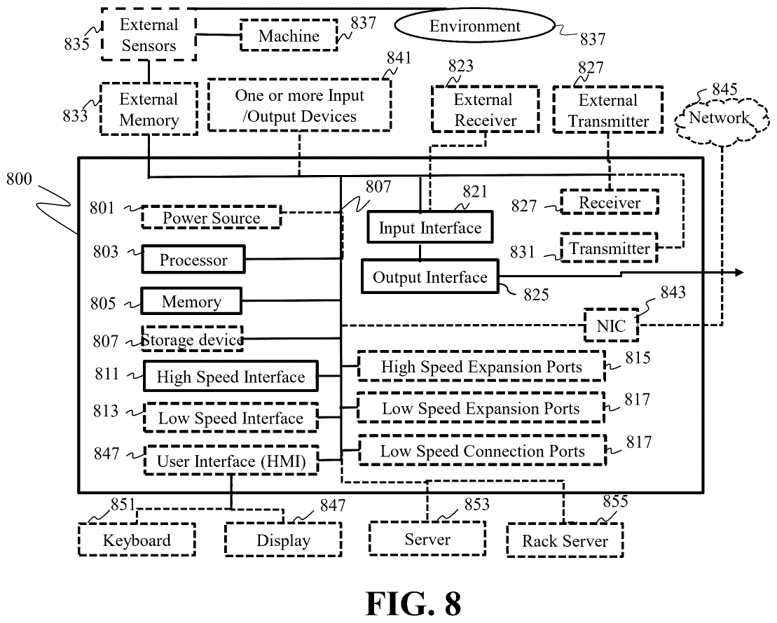

FIG. 8 is a schematic illustrating by non-limiting example a computing apparatus for implementing the methods and the systems of the present disclosure. The computing device 800 can include a power source 801, a processor 803, a memory 805, a storage device 807, all connected to a bus 809. Further, a high-speed interface 811, a low-speed interface 813, high-speed expansion ports 815 and low speed connection ports 817, can be connected to the bus 809. In addition, a low-speed expansion port 819 is in connection with the bus 809. Further, an input interface 821 can be connected via the bus 809 to an external receiver 823 and an output interface 825. A receiver 827 can be connected to an external transmitter 829 and a transmitter 831 via the bus 809. Also connected to the bus 809 can be an external memory 833, external sensors 835, machine(s) 837, and an environment 839. Further, one or more external input/output devices 841 can be connected to the bus 809. A network interface controller (NIC) 843 can be adapted to connect through the bus 809 to a network 845, wherein data or other data, among other things, can be rendered on a third-party display device, third party imaging device, and/or third-party printing device outside of the computer device 800.

The memory 805 can store instructions that are executable by the computer device 800, historical data, and any data that can be utilized by the methods and systems of the present disclosure. The memory 805 can include random access memory (RAM), read only memory (ROM), flash memory, or any other suitable memory systems. The memory 805 can be a volatile memory unit or units, and/or a non-volatile memory unit or units. The memory 805 may also be another form of computer-readable medium, such as a magnetic or optical disk.

The storage device 807 can be adapted to store supplementary data and/or software modules used by the computer device 800. For example, the storage device 807 can store historical data and other related data as mentioned above regarding the present disclosure. Additionally, or alternatively, the storage device 807 can store historical data like data as mentioned above regarding the present disclosure. The storage device 807 can include a hard drive, an optical drive, a thumb-drive, an array of drives, or any combinations thereof. Further, the storage device 807 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 803), perform one or more methods, such as those described above.

The computing device 800 can be linked through the bus 809, optionally, to a display interface or user Interface (HMI) 847 adapted to connect the computing device 800 to a display device 849 and a keyboard 851, wherein the display device 849 can include a computer monitor, camera, television, projector, or mobile device, among others. In some implementations, the computer device 800 may include a printer interface to connect to a printing device, wherein the printing device can include a liquid inkjet printer, solid ink printer, large-scale commercial printer, thermal printer, UV printer, or dye-sublimation printer, among others.

The high-speed interface 811 manages bandwidth-intensive operations for the computing device 800, while the low-speed interface 813 manages lower bandwidth-intensive operations. Such allocation of functions is an example only. In some implementations, the high-speed interface 811 can be coupled to the memory 805, the user interface (HMI) 847, and to the keyboard 851 and the display 849 (e.g., through a graphics processor or accelerator), and to the high-speed expansion ports 815, which may accept various expansion cards via the bus 809. In an implementation, the low-speed interface 813 is coupled to the storage device 807 and the low-speed expansion ports 817, via the bus 809. The low-speed expansion ports 817, which may include various communication ports (e.g., USB, Bluetooth, Ethernet, wireless Ethernet) may be coupled to the one or more input/output devices 841. The computing device 800 may be connected to a server 853 and a rack server 855. The computing device 800 may be implemented in several different forms. For example, the computing device 800 may be implemented as part of the rack server 855.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A method for controlling a mechanical device in a collaborative environment to synchronize its actions with a task progress of an agent, wherein the method uses a processor coupled with stored instructions implementing the method, wherein the instructions, when executed by the processor carry out steps of the method, comprising:
receiving, in real time, a task completion percentage of a task being performed by the agent, wherein the task completion percentage is dynamically estimated from observations of task progress data;
receiving an elapsed time since initiation of the task by the agent;
combining the task completion percentage and the elapsed time into an input state representation;
executing a trained policy derived from a reinforcement learning to determine, based on the input state representation, an action for the mechanical device; and
controlling the mechanical device according to the determined action.

2. The method of claim 1, wherein the determined action minimizes an idle time of one or a combination of the mechanical device and the agent.

3. The method of claim 2, wherein the trained policy derived from the reinforcement learning is trained based on a training process comprising:
collecting demonstration data of tasks performed by a population of agents, the demonstration data including real-time task progress trajectories and corresponding elapsed times for each task;
estimating task completion percentages from the demonstration data using a time-series analysis algorithm, wherein the algorithm accounts for variability in the real-time task progress trajectories;
forming an input state representation for the mechanical device by combining the estimated task completion percentages and the elapsed times;
defining a reward function configured to minimize the idle time of the mechanical device and the agent; and
training the policy using the reinforcement learning based on the input state representation, the reward function, and the demonstration data to generate the trained policy.

4. The method of claim 2, wherein the idle time includes a weighted combination of an idle time of the mechanical device and an idle time of agent, wherein weights of the weighted combination are configurable.

5. The method of claim 3, wherein the algorithm is a covariance based open-ended Dynamic Time Warping (DTW) algorithm configured to account for variability in the task progress trajectories.

6. The method of claim 5, wherein, to estimate the task estimation the task completion percentages using the covariance based open-ended DTW algorithm, the method further comprises:
calculating a normalized covariance-based distance metric between segments of the task progress trajectories to account for variability in the task progress trajectories, the normalized covariance-based distance metric being invariant to shifts in position or amplitude of the task progress trajectories;
applying a real-time, open-ended DTW alignment to match task the progress trajectories to a reference trajectory of the task, wherein the reference trajectory represents a baseline or typical execution of the task; and
generating an estimated task completion percentage as a continuous function of the alignment between the task progress trajectories and the reference trajectory.

7. The method of claim 3, wherein the reinforcement learning used for training the policy includes a Proximal Policy Optimization (PPO).

8. The method of claim 1, wherein the agent is a user performing a manual task, and the mechanical device is an assembly robot configured to assist the user to perform the manual task.

9. The method of claim 1, wherein the action includes passing a tool, moving the tool, holding the tool to support the agent, or jointly transporting an assembly piece.

10. The method of claim 1, wherein the mechanical device is an ego robot and the agent is another robot collaborating with the ego robot in a robotic multi-agent system.

11. A system for controlling a mechanical device in a collaborative environment to synchronize its actions with a task progress of an agent, comprising: a processor; and a memory having instructions stored thereon that, when executed by the processor, cause the system to:
receive, in real time, a task completion percentage of a task being performed by the agent, wherein the task completion percentage is dynamically estimated from observations of task progress data;
receive an elapsed time since initiation of the task by the agent;
combine the task completion percentage and the elapsed time into an input state representation;
execute a trained policy derived from a reinforcement learning to determine, based on the input state representation, an action for the mechanical device; and
control the mechanical device according to the determined action.

12. The system of claim 11, wherein the determined action minimizes an idle time of one or a combination of the mechanical device and the agent.

13. The system of claim 12, wherein the trained policy derived from the reinforcement learning is trained based on a training process comprising:
collecting demonstration data of tasks performed by a population of agents, the demonstration data including real-time task progress trajectories and corresponding elapsed times for each task;
estimating task completion percentages from the demonstration data using a time-series analysis algorithm, wherein the algorithm accounts for variability in the real-time task progress trajectories;
forming an input state representation for the mechanical device by combining the estimated task completion percentages and the elapsed times;
defining a reward function configured to minimize the idle time of the mechanical device and the agent; and
training the policy using the reinforcement learning based on the input state representation, the reward function, and the demonstration data to generate the trained policy.

14. The system of claim 12, wherein the idle time includes a weighted combination of an idle time of the mechanical device and an idle time of agent, wherein weights of the weighted combination are configurable.

15. The system of claim 13, wherein the algorithm is a covariance based open-ended Dynamic Time Warping (DTW) algorithm configured to account for variability in the task progress trajectories.

16. A non-transitory computer-readable storage medium embodied thereon a program executable by a processor for performing a method for controlling a mechanical device in a collaborative environment to synchronize its actions with a task progress of an agent, the method comprising:
receiving, in real time, a task completion percentage of a task being performed by the agent, wherein the task completion percentage is dynamically estimated from observations of task progress data;
receiving an elapsed time since initiation of the task by the agent;
combining the task completion percentage and the elapsed time into an input state representation;
executing a trained policy derived from a reinforcement learning to determine, based on the input state representation, an action for the mechanical device; and
controlling the mechanical device according to the determined action.

17. The non-transitory computer-readable storage medium of claim 16, wherein the determined action minimizes an idle time of one or a combination of the mechanical device and the agent.

18. The non-transitory computer-readable storage medium of claim 17, wherein the trained policy derived from the reinforcement learning is trained based on a training process comprising:
collecting demonstration data of tasks performed by a population of agents, the demonstration data including real-time task progress trajectories and corresponding elapsed times for each task;
estimating task completion percentages from the demonstration data using a time-series analysis algorithm, wherein the algorithm accounts for variability in the real-time task progress trajectories;
forming an input state representation for the mechanical device by combining the estimated task completion percentages and the elapsed times;
defining a reward function configured to minimize the idle time of the mechanical device and the agent; and
training the policy using the reinforcement learning based on the input state representation, the reward function, and the demonstration data to generate the trained policy.

19. The non-transitory computer-readable storage medium of claim 17, wherein the idle time includes a weighted combination of an idle time of the mechanical device and an idle time of agent, wherein weights of the weighted combination are configurable.

20. The non-transitory computer-readable storage medium of claim 18, wherein the algorithm is a covariance based open-ended Dynamic Time Warping (DTW) algorithm configured to account for variability in the task progress trajectories.
